(19) United States
(12) Patent Application Publication
(10) Pub. No.: US 2003/0084217 A1
(43) Pub. Date: May 1, 2003

(54) Method and apparatus for sending data toward a network destination

(76) Inventor: David A. Griego, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/002,656

(22) Filed: Oct. 31, 2001

(51) Int. Cl. G06F 13/42

(52) U.S. Cl. 710/105

(57) ABSTRACT

A method and apparatus for sending information on a network comprising of receiving a message from a host computer, the message comprising of header information and data descriptors about data that is transmitted with the header information. Obtaining the data from the host computer, inserting the data in the message, and sending the message toward its destination.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND OF THE INVENTION

1. Field of the Invention

The present invention is related to the field of electronics. In particular, the present invention is related to a method and apparatus for sending data toward a network destination.

2. Description of the Related Art

In networked computer systems there exists a need for sending and receiving large amounts of data via a network (e.g., a local area network (LAN), a wide area network (WAN), or the Internet) in the shortest possible time. One method to satisfy this need is through the use of an input/output (I/O) architecture that includes an I/O processor and associated software modules that reside on a peripheral bus (e.g., a peripheral interconnect (PCI) bus). FIG. 1 illustrates a method and apparatus for communicating between a host computer and a network interface card in accordance with a prior art embodiment. FIG. 1 illustrates an I/O architecture 100 wherein large amounts of data are processed by offloading low-level interrupts from a host processor to the I/O processor that resides on a separate bus (e.g., the PCI bus).

As illustrated in FIG. 1, host machine 101 comprising at least a host processor 105 is communicatively coupled with memory 115 (e.g., synchronous dynamic random access memory (SDRAM)) via host bus 110. Host machine 101 is communicatively coupled with I/O system 172 via a PCI bus 120. In particular, I/O system 172 includes I/O processor 125 that is communicatively coupled with local I/O memory 135 via local memory bus 130. In addition, I/O processor 125 is communicatively coupled with operating system 140 (e.g., an intelligent real time operating system (IRTOS)). IRTOS 140 provides a platform for communications between I/O processor 125 and modules such as device drivers and service modules (e.g., intermediate service modules (ISMs)). A device driver may be a hardware device module (HDM) (not shown) that may reside on and interface with an adapter (e.g., a network adapter). An ISM 145 is a software module that communicates with the IRTOS and provides special functionality such as building transmission control protocol/internet protocol (TCP/IP) (see request for comment (RFC) 793 and RFC 879) messages, or performing some special function e.g., calculating the checksum of all data packets arriving to and from I/O processor 125. The I/O processor along with the IRTOS and the associated modules comprise I/O system 172 that handles at least all the I/O operations for the host system.

In order to provide flexibility and support for combinations of I/O devices and operating systems, host machine 101, IRTOS 140, and the intermediate service module 145 communicate with each other using messages. Communicating via the use of messages provides a layer of abstraction and flexibility as the modules communicate with each other without knowledge of the underlying bus architecture or of the system topology. In order to communicate using messages, the data associated with the messages is transferred, via descriptors in the message, from the host machine (host) 101 to local I/O memory 135 using IOP 125. In particular, IOP uses a direct memory access (DMA) cycle to copy the data described in the descriptors from host memory 115 to local I/O memory 135. Once the ISM constructs a message (e.g., a TCP/IP message) using descriptors for the message header and the data (payload), the message is sent to the network interface card (NIC) 150. The NIC uses the descriptors to obtain the message header information and the data from local I/O memory 135 and sends the message including the data toward its destination.

However, having to copy the data for the message from host memory 115 to local I/O memory 135, and having to populate the message with the data from local I/O memory 135 for transmission toward its network destination is inefficient and slow.

### BRIEF SUMMARY OF THE DRAWINGS

Examples of the present invention are illustrated in the accompanying drawings. The accompanying drawings, however, do not limit the scope of the present invention. Similar references in the drawings indicate similar elements.

FIG. 1 illustrates a method and apparatus for sending data toward a network destination in accordance with a prior art embodiment;

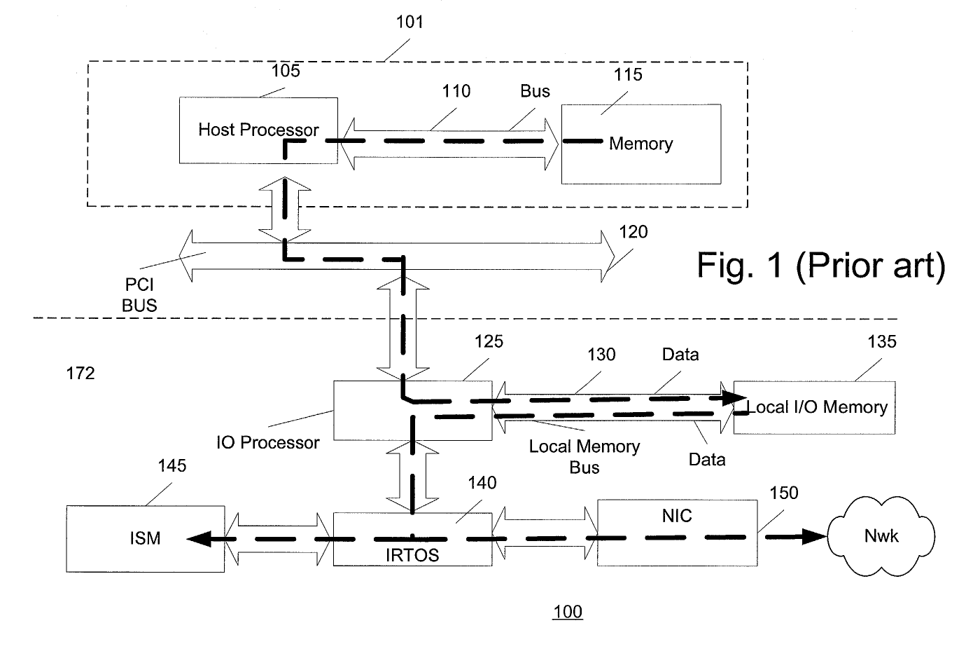

FIG. 2 illustrates a flow diagram for communicating sending data toward a network destination according to one embodiment of the invention;

FIG. 3 illustrates a block diagram of a computer system according to one embodiment of the invention;

FIG. 4 is a block diagram of a machine accessible medium according to one embodiment of the invention.

### DETAILED DESCRIPTION OF THE INVENTION

Described is a method and apparatus for sending data toward a network destination. In the following description, numerous specific details are set forth in order to provide a thorough understanding of the present invention. It will be apparent, however, to one of ordinary skill in the art that the present invention may be practiced without these specific details. In other instances, well-known architectures, steps, and techniques have not been shown to avoid unnecessarily obscuring the present invention. For example, specific details are not provided as to whether the method is implemented in a router, switch, modem, as a software routine, hardware circuit, firmware, or a combination thereof.

Parts of the description will be presented using terminology commonly employed by those skilled in the art to convey the substance of their work to others skilled in the art. Also, parts of the description will be presented in terms of operations performed through the execution of programming instructions. As well understood by those skilled in the art, these operations often take the form of electrical, magnetic, or optical signals capable of being stored, transferred, combined, and otherwise manipulated through, for instance, electrical components.

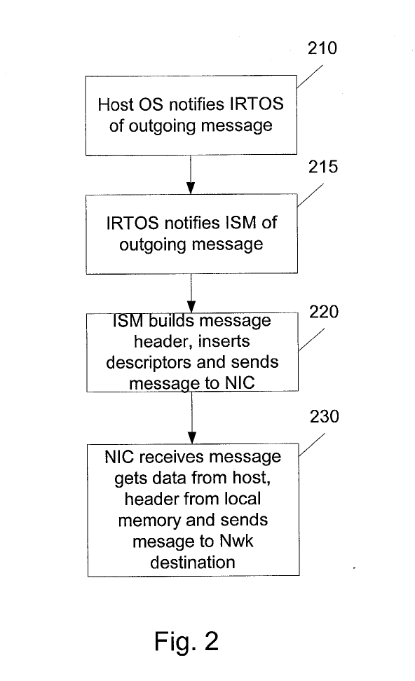

FIG. 2 illustrates a flow diagram for sending data toward a network destination according to one embodiment of the invention. In one embodiment, during initialization of the I/O system the ISM is made aware of the capabilities of the NIC. In particular, the ISM is aware that the NIC has the capability to retrieve header information for a message (e.g., header information for a TCP/IP message) from local I/O memory and to obtain the data for the message directly from host memory.

As illustrated in flow diagram 200 of FIG. 2, at 210, an IRTOS on an I/O system receives a message from a host computer that includes descriptors that point to at least the memory address location of the data on host computer memory, and the amount of data (e.g., the byte size) that is to be included with the message. At 215, the IRTOS sends the message received from the host to an ISM. At 210, the ISM determines that the message is bound for a network destination and, at 220 the ISM constructs the message in accordance with an appropriate protocol (e.g., using the TCP/IP protocol) using the header information specified by that protocol. One skilled in the art will appreciate that other protocols such as SPX/IPX, NetBIOS/NetBEUI etc. may alternately be used. In one embodiment, the ISM uses header descriptors for the header information in the message and stores the information corresponding with the header descriptors in local I/O memory.

However, once the ISM builds the message (e.g., using the header descriptors), the ISM sends the message along with data descriptors for the data (i.e., descriptors that point to the memory location of the data on the host memory) to the NIC. In one embodiment, the ISM may construct the message with the actual message header information instead of using header descriptors, and send the message with the data descriptors to the NIC. In another embodiment, the ISM may construct a message either with the header descriptors, or with the header information, and obtain the data for the message directly from the host memory using a DMA access cycle and send the message to the MC for transmission toward its destination. In one embodiment, the data descriptors include the type of data, the amount of data and the location of the data in the message.

In one embodiment, at 230, the NIC receives the message from the ISM and uses the header descriptors to retrieve the header information for the message from local I/O memory (e.g., the I/O processor (IOP) memory). In addition, the NIC uses the data descriptors to obtain the data directly from the host memory (e.g., using a PCI to PCI bridge), and sends the message including the data toward its destination. One skilled in the art will appreciate that when a PCI to PCI bridge is used a common memory address space is shared by components on the PCI bus. Thus, a NIC that is communicatively coupled with modules (e.g., the ISM) on a PCI bus may access the data in host memory via a DMA cycle since the host memory is also communicatively coupled with the PCI bus.

Using the process described above, the data may be copied by the NIC directly from host memory. Thus, the process of copying data from host memory to local I/O memory and then copying the data from I/O memory into the message is avoided. This significantly speeds up the transmission of data from a host to a network destination since the copying of data from host memory to local I/O memory is avoided.

The invention described herein may utilize a distributed computing environment. In a distributed computing environment, program modules may be physically located in different local and remote memory storage devices. Execution of the program modules may occur locally in a stand-alone manner or remotely in a client/server manner. Examples of such distributed computing environments include local area networks, enterprise-wide computer networks, and the Internet.

Various operations will be described as multiple discrete steps performed in turn in a manner that is helpful in understanding the present invention. However, the order of description should not be construed to imply that these operations are necessarily performed in the order they are presented, or even order dependent. Lastly, repeated usage of the phrase “in one embodiment” does not necessarily refer to the same embodiment, although it may.

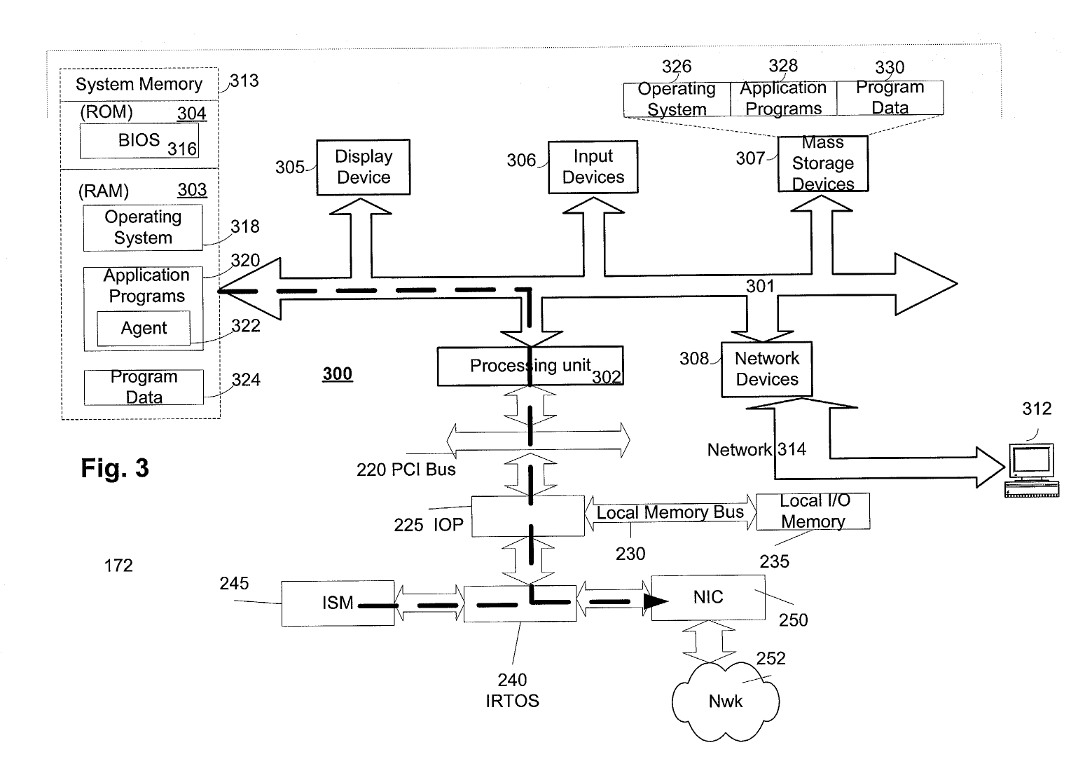

FIG. 3 illustrates a block diagram of a computer system according to one embodiment of the invention. Although the description that follows illustrates an ISM and an IRTOS as separate modules, one skilled in the art will appreciate that the ISM and the IRTOS may be combined into one module that interfaces with the NIC and the I/O processor. Although the method and apparatus described uses a PCI bus, one skilled in the art will appreciate that the technique may be used with other buses including but not limited to an extended industry standard architecture (EISA) bus, a universal serial bus (USB) etc.

FIG. 3 illustrates a computer system in which the present invention operates. One embodiment of the present invention is implemented using personal computer (PC) architecture. It will be apparent to those of ordinary skill in the art that alternative computer system architectures or other processor, programmable or electronic-based devices may also be employed.

In general, computer system 300 includes a processing unit 302 (i.e., a host processor) coupled through a bus 301 to a system memory 313. System memory 313 comprises a read only memory (ROM) 304, and a random access memory (RAM) 303 (i.e., host memory). ROM 304 comprises Basic Input Output System (BIOS) 316, and RAM 303 comprises operating system 318. Application programs 320, agent 322, and program data 324.

In one embodiment, Agent 322 comprises the executable program that informs the ISM of the capabilities of the NIC 250, and sends a message with appropriate data descriptors to ISM 245. Alternately, the executable program that informs the ISM of the capabilities of the NIC may reside on I/O system 172. In one embodiment, the ISM receives a message from a host machine, the message comprising header information and data descriptors about the data that is transmitted with the header information. In one embodiment, the data descriptors include the type of data, the amount of data and the location of the data in the message. In one embodiment, the ISM retrieves the data directly from the host memory 303 and sends the data to NIC 250 for transmission to the message's network destination. In another embodiment, the ISM receives a message from a host machine, the message comprising header information and data descriptors about the data that is to be transmitted with the header information. The ISM constructs a message according to a protocol (e.g., a TCP/IP protocol) and includes header descriptors in the message that correspond with header information stored in local I/O memory 235. The message may also include descriptors for data that is stored in host memory 303. The message constructed by ISM 245 is sent to NIC 250 via IRTOS 240. The NIC uses the header descriptors to obtain the header information stored in local I/O memory 235. The NIC may also obtain the data for the message directly from host memory 303 using the descriptors in the message received from ISM (using e.g., a DMA cycle) and sends the data toward its network destination. In one embodiment, in accordance with the protocol used, the NIC performs parity checks on the data that is received from the host and may keep track of packet sequence numbers etc. to ensure proper transmission of the data toward its network destination.

Computer system 300 includes mass storage device 307, Input devices 306 and display device 305 coupled to processing unit 302 via bus 301. Mass storage device 307 represents a persistent data storage device, such as a floppy disk drive, fixed disk drive (e.g., magnetic, optical, magneto-optical, or the like), or streaming tape drive. Mass storage device stores Program data 330, application programs 328, and operating system 326. Application programs 328 may include agent software 322. Processing unit 302 may be any of a wide variety of general purpose processors or microprocessors (such as the Pentium® processor manufactured by Intel® Corporation), a special purpose processor, or even a specifically programmed logic device.

In one embodiment, the processing unit 302 is operable to receive instructions which, when executed by the processing unit, causes the processing unit to execute the instructions of agent 322.

Display device 305 provides graphical output for computer system 300. Input devices 306 such as a keyboard or mouse are coupled to bus 301 for communicating information and command selections to processor 302. Also coupled to processor 302 through bus 301 are one or more network devices 308 (e.g., a network interface card) that can be used to control and transfer data to electronic devices (printers, other computers, etc.) connected to computer 300. Network devices 308 also connect computer system 300 to a network, 314, and may include Ethernet devices, phone jacks and satellite links, for example, to connect computer system 300 to remote computer 312. It will be apparent to one of ordinary skill in the art that other network devices may also be utilized.

In one embodiment, processing unit 302 is communicatively coupled to I/O processor 225, via a bus 220 (e.g., a PCI bus). I/O processor 225 is communicatively coupled with I/O processor local I/O memory 235 via local I/O memory bus 230. In addition, I/O processor 225 is communicatively coupled with operating system module 240 (e.g., an intelligent real time operating system (IRTOS)). Operating system module 240 provides a platform for communications between I/O processor 225 and modules such as device drivers. A device driver may be a hardware device module (HDM) (not shown) which may reside on and interface with an adapter (e.g., a network adapter), or an intermediate service module (ISM), 245, that provides special functionality such as building a TCP/IP message, or performing some special function e.g. calculating the checksum of all packets arriving to and from I/O processor 225. The I/O processor along with the IRTOS and the associated modules comprise an I/O system that handles at least all the I/O operations between the host system and a network.

One embodiment of the invention may be stored entirely as a software product on mass storage 307. Another embodiment of the invention may be embedded in a hardware product (not shown), for example, in a printed circuit board, in a special purpose processor, or in a specifically programmed logic device communicatively coupled to bus 301. Still other embodiments of the invention may be implemented partially as a software product and partially as a hardware product.

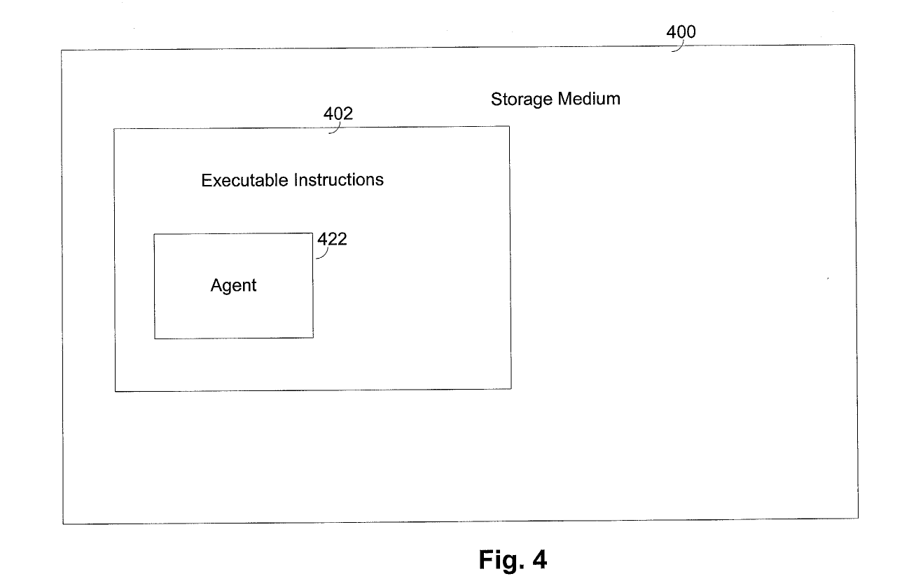

FIG. 4 is a block diagram of a machine accessible medium according to one embodiment of the invention. Embodiments of the invention may be represented as a software product stored on a machine-accessible medium 400 (also referred to as a computer-accessible medium or a processor-accessible medium). The machine-accessible medium 400 may be any type of magnetic, optical, or electrical storage medium including a diskette, CD-ROM, memory device (volatile or non-volatile), or similar storage mechanism. The machine-accessible medium may contain various sets of instructions 402, code sequences, configuration information, or other data. Those of ordinary skill in the art will appreciate that other instructions and operations necessary to implement the described invention may also be stored on the machine-accessible medium.

The machine-accessible medium comprises instructions, incorporated in agent 422, that when executed by a machine causes the machine to perform operations comprising informing the ISM of the capabilities of the NIC, and sending network messages from a host computer to the ISM with appropriate data descriptors. In alternate embodiments, the machine-accessible medium comprises instructions that construct a message with the appropriate header and data descriptors. In particular, the machine-accessible medium comprises instructions for an ISM to receive a message from a host machine, the message comprising header information and data descriptors about the data that is transmitted with the header information. In one embodiment, the data descriptors include the type of data, the amount of data and the location of the data in the message. In one embodiment, the ISM retrieves the data directly from the host memory and sends the data to a NIC for transmission to the message's network destination. In another embodiment, the ISM receives a message from a host machine, the message comprising header information and data descriptors about the data that is transmitted with the header information. The ISM constructs a message according to a protocol (e.g., a TCP/IP protocol) and includes header descriptors in the message that correspond with header information stored in local I/O memory. The message may also include descriptors for data that is stored in host memory. The message constructed by the ISM may be sent to a NIC via IRTOS. The NIC uses the header descriptors to obtain the header information stored in local I/O memory and sends the information via network. In addition the NIC may obtain the data directly from host memory using the descriptors in the message received from ISM (using a DMA cycle) and sends the data toward its network destination. In one embodiment, in accordance with the protocol used, the NIC performs parity checks on the data that is received and may keep track of packet sequence numbers etc. to ensure proper transmission of the data toward its network destination.

Thus, a method and apparatus have been disclosed for sending data toward a network destination. While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A method comprising:
receiving a message, the message comprising header information and data descriptors about data that is transmitted with the header information;
obtaining the data from a host, said host remotely disposed with respect to an input/output (I/O) processor;
inserting the data in the message; and
sending the message toward its destination.

2. The method of claim 1 wherein the header information comprises header descriptors for a transmission control protocol/internet protocol (TCP/IP) header.

3. The method of claim 2 wherein the header information is obtained from local I/O memory using the header descriptors.

4. The method of claim 1 wherein the data descriptors define at least the type of data, the amount of data and the location of the data in the message.

5. The method of claim 1 wherein obtaining the data from the host comprises using the data descriptors to obtain the data from a host that is remotely disposed with the I/O processor via a bus.

6. The method of claim 5 wherein the bus is at least one of a peripheral component interconnect (PCI) bus, an EISA bus and a PCIX bus.

7. The method of claim 1 wherein obtaining the data from the host comprises obtaining the data from the host via a direct memory access (DMA) cycle.

8. The method of claim 1 wherein the message is received by any one of a network interface card, and an intermediate software module locally disposed with respect to the I/O processor.

9. The method of claim 1 wherein obtaining the data from the host comprises receiving the data via a PCI to PCI bridge.

10. A computer system comprising:
a bus communicatively coupled with a host;
an I/O processor communicatively coupled with the bus and an I/O module;
a network interface card (NIC) communicatively coupled with the processor said NIC to
receive a message, the message comprising header information and data descriptors about data that is transmitted with the header information;
obtain the data from a host, said host remotely disposed with respect to an input/output (I/O) processor;
insert the data in the message; and
send the message toward its destination.

11. The apparatus of claim 10 wherein the header information comprises header descriptors for a transmission control protocol/internet protocol (TCP/IP) header.

12. The apparatus of claim 10 wherein the header information is obtained from local I/O memory using the header descriptors.

13. The apparatus of claim 10 wherein the data descriptors define at least the type of data, the amount of data and the location of the data in the message.

14. The apparatus of claim 10 wherein the NIC to receive the data from the host comprises the NIC receiving the data from a host that is remotely disposed with the I/O processor via at least one of a peripheral component interconnect (PCI) bus, an EISA bus and a PCIX bus.

15. The apparatus of claim 10 wherein the NIC to obtain the data from the host comprises the NIC to obtain the data from the host via a direct memory access (DMA) cycle.

16. An article of manufacture comprising:
a machine-accessible medium including instructions that, when executed by a machine, causes the machine to perform operations comprising
receiving a message, the message comprising header information and data descriptors about data that is transmitted with the header information;
obtaining the data from a host, said host remotely disposed with respect to an input/output (I/O) processor;
inserting the data in the message; and
sending the message toward its destination.

17. The article of manufacture as in claim 16, wherein the instructions for receiving a message comprising header information comprises further instructions for receiving header descriptors for a transmission control protocol/internet protocol (TCP/IP) header.

18. The article of manufacture as in claim 17, wherein instructions for receiving a message comprising header information includes further instructions for obtaining header information from local I/O memory using the data descriptors.

19. The article of manufacture as in claim 16, wherein said instructions for receiving a message, the message comprising header information and data descriptors about data that is transmitted comprises further instructions for the data descriptors defining at least the type of data, the amount of data and the location of the data in the message.

20. The article of manufacture as in claim 16, wherein said instructions for obtaining the data from a host comprises further instructions for obtaining data from a host that is remotely disposed with the I/O processor via a peripheral component interconnect (PCI) bus, an EISA bus and a PCIX bus.

21. The article of manufacture of claim 16 wherein said instructions for obtaining the data from the host comprises further instructions for obtaining the data from the host via a direct memory access (DMA) cycle.

22. The article of manufacture of claim 16, wherein said instructions for receiving a message comprises further instructions for any one of a network interface card, and an intermediate software module locally disposed with respect to the I/O processor receiving the message.

23. An apparatus comprising:
a bus; and
a network interface card (NIC) coupled to the bus, said NIC to
receive a message, the message comprising header information and data descriptors about data that is transmitted with the header information;
obtain the data from a host, said host remotely disposed on the bus with respect to the NIC;
insert the data in the message; and
send the message toward its destination.

24. The NIC of claim 23 wherein the header information comprises header descriptors for a transmission control protocol/internet protocol (TCP/IP) header.

25. The NIC of claim 23 wherein the header information is obtained from local I/O memory using the header descriptors.

26. The NIC of claim 23 wherein the data descriptors define at least the type of data, the amount of data and the location of the data in the message.

27. The NIC claim 23 wherein obtaining the data from the host comprises using the data descriptors to obtain the data from a host that is remotely disposed with the I/O processor via a bus.

28. The NIC of claim 27 wherein the bus is at least one of a peripheral component interconnect (PCI) bus, an EISA bus and a PCIX bus.

29. The NIC of claim 23 wherein obtaining the data from the host comprises obtaining the data from the host via a direct memory access (DMA) cycle.

30. The NIC of claim 23 wherein obtaining the data from the host comprises receiving the data via a PCI to PCI bridge.
